(19) United States
(12) Patent Application Publication
(10) Pub. No.: US 2016/0343014 A1
(43) Pub. Date: Nov. 24, 2016

(54) HANDHELD DEVICES INTEGRATED WITH LOCATION BASED PRODUCT DEMONSTRATION, REFERRAL AND DIRECT SALES CHANNEL SYSTEM

(71) Applicant: Spyf, Inc., Dover, DE (US)

(72) Inventor: Michael J. White, Brooklyn, NY (US)

(21) Appl. No.: 15/162,520

(22) Filed: May 23, 2016

Related U.S. Application Data
(60) Provisional application No. 62/165,194, filed on May 22, 2015.

(51) Int. Cl. G06Q 30/02; H04W 4/02; G06Q 30/06; G06Q 20/32; G06F 17/30; G06Q 10/10

(52) U.S. Cl. CPC G06Q 30/0214; G06F 17/30867; G06Q 30/0205; G06Q 10/1095; G06Q 30/0623; G06F 17/3087; G06Q 20/3224; H04W 4/023

(57) ABSTRACT

The disclosed technology describes methods and systems for an efficient product demonstration. In some embodiments, a request for a demonstration of a product or a service is received from a computing device of a prospective buyer of a product. A database of registered existing customers is searched search to identify an existing customer of the product or the service to provide the demonstration in exchange for a referral fee. A meeting for the demonstration is arranged by the server, and when a purchase of the product or service is received from the computing device of the prospective buyer, a notification is sent to a provider of the product or service. The existing customer can then receive a referral fee.

### CROSS-REFERENCE TO RELATED APPLICATIONS

This application claims the benefit of and is a non-provisional of U.S. Provisional Patent Application No. 62/165,194, entitled “Location Based Product Demonstration, Referral and Direct Sales Channel System and Method,” filed May 22, 2015, which is hereby incorporated by reference in its entirety for all purposes.

### BACKGROUND

Several systems have been proposed for location-based marketing and sales facilitated by computers, mobile devices, and software (US 20120036014 A1). These systems allow consumers to search for specific products and then locate vendors of these products near them. Vendors can incentivize these location-based searches with promotions, such as time-sensitive discounts, to encourage urgency to complete the sale. The proposed systems are designed to connect consumers with a local retail or commercial establishment, such as a showroom or retail store which often maintain inventory on premise.

More and more companies are selling products through direct sales channels. Several trends are encouraging this development. The internet allows for extensive online product catalogs that can be produced and updated at low cost with minimal marginal cost at scale. Advanced logistic systems integrate ordering, warehousing and product fulfillment, and returns, and can now be completely handled by optimized third parties such as Amazon.com. In addition, many long established retail sales channels are being driven out of the market for various competitive reasons, such as Circuit City® and more recently Radio Shack®. Even stores like Sears® and JC Penny® are struggling with their retail business model. It is now simpler and more competitive than ever for companies to switch to a direct sales models. However, many consumers are hesitant to buy higher priced products, technical, unique, or luxury items without first getting to inspect, see, and experience the product first in person. There is no simple means for people to get product demonstrations in their locality.

Marketing research has shown that word of mouth marketing between consumers is the most effective for conversion to actual sales. Numerous referral programs (U.S. Pat. No. 6,029,141 A, U.S. Pat. No. 7,337,133 B1) have been developed to incentive customers to refer their friends, family, and colleagues to encourage purchases. Incentives can include cash commissions, points, discounts, gift cards, and so forth. These referral systems are mainly designed to work online—for example consumers can engage in word of mouth marketing by posting product eCommerce links on social media. In the brick and mortar world, word of mouth marketing is facilitated by coupons or other physical collateral.

### BRIEF DESCRIPTION OF THE DRAWINGS

FIG. 1 is one embodiment of the shopping device with display and various controls to initiate tasks including communications, searching products, searching for a demonstration opportunity, and buying the product direct from the product manufacturer. The shopping device may also include an onboard printer for generating coupons. Alternately coupon codes can be shown on the display.

FIG. 2A shows a prospective buyer using the shopping device to search for products and existing customers nearby to schedule a product demonstration. The shopping device communicates with central servers which in turn notify existing customers who already own the product that an in-person demonstration has been requested near their current location.

FIG. 2B shows the prospective customer meeting with the existing customer for a hands-on demonstration, in this example a demo of a fishing pole—they are both located in a park. The prospective buyer can use the shopping device to place an order during the meeting. The shopping device can generate a coupon for a discount.

FIG. 2C shows the buyer receiving his or her own fishing pole via a delivery truck, presumably later that week. The shopping device can display data about the shipment.

FIG. 3 is a flow diagram showing various steps in the communication and search operations performed by the system.

The techniques introduced here may be better understood by referring to the following Detailed Description in conjunction with the accompanying drawings, in which like reference numerals indicate identical or functionally similar elements.

### DETAILED DESCRIPTION

Embodiments of the disclosed technology include one or more specialized hand held shopping devices connected to wireless or wired computer networks allowing a shopper to search for an existing customer to demonstrate a product in person to said prospective consumer and then begin a direct sales process with the product company that sells the product direct. The sales process can include initial marketing activities all the way through to purchase and fulfillment. The handheld shopping device further allows a shopper to search for existing customers located near them that would be willing to meet and demonstrate a specific product in their home or other location that can then be purchased through a direct sales channel. The handheld shopping device further allows a shopper to browse products on said handheld shopping device showing products available near their current location and arrange for product demonstrations with existing customers, and allows these existing customers to be incentivized with compensation for demonstrating these products. All aspects of these interactions are initiated and managed on the handheld shopping device. The shopping device can also generate redeemable coupons via an onboard printer or shown on the included display or other output. In some embodiments, the handheld shopping device is a mobile phone, tablet or other device that runs an application capable of performing the activities described herein.

In some embodiments, one or more handheld shopping devices are integrated with computers running software, backend servers running software, integrated services, prospective customers with the shopping device, existing customers with the shopping device who have purchased and possess a product(s) the prospective customer is interested in, the company that sells the product(s) and their direct sales channel, and a referral system to incentivize and compensate the existing customer to demonstrate the product to prospective customers. Existing customers are encouraged by the product company to use the shopping device and to enter the referral program. Existing customers can demonstrate the product in person to prospective customers and then use the shopping device to begin a direct sales channel purchase. The prospective customer after viewing the product in person can enter their email or phone number into the shopping device.

Alternatively, the prospective customer can search online for product(s) near their location that are available for first hand demonstration and make appointments with existing customers for demonstrations. The linked servers and databases can then link the prospective customer and the existing customer for later use in the referral system. The prospective consumer's contact information is also now recorded for future marketing efforts by the product company. The shopping device can be integrated with calendaring, mapping, and communication systems to facilitate meeting times and locations and communications. The prospective consumer can use the shopping device to further continue the purchasing process by entering payment and shipping information after the product demonstration. This information can be submitted for payment processing and direct product fulfillment through one or more integrated eCommerce platforms. Once the prospective customer purchases a product, they can be invited to enter the referral program thereby enlarging the network and can receive requests for product demonstrations. Also, a product company can invite existing consumers into the referral system based on previous order history. Or a user can be prompted to enter the referral system for a product they already own that is available for purchase within the network. After each purchase, the referring existing customer is notified via the shopping device of their referral compensation.

Accordingly several advantages are provided by this technology. For example, the system allows individuals near each other to quickly and efficiently meet one another for product demonstrations, which is faster than going to a far-away show room or retail store. The system also allows product companies to automatically scale their distribution channel at low up front cost by automatically inviting customers to enter the system through automated workflows on the shopping device and by recording new customer information in various databases. The system further allows prospective customers the opportunity to personally inspect, see, and experience a product that is typically available only through a direct sales channel and is otherwise not viewable firsthand locally. The system benefits product companies in that they can engage in a direct sales channel but still allow for firsthand demonstrations without the expense or logistics of resellers or other retail sales channel, it relies on word of mouth marketing—the most effective form of product marketing—leading to high purchase conversion rates. The system allows prospective customers to have a product demonstration in a real use case environment rather than a manipulated retail setting. The system further allows prospective consumers to interact with existing customers getting legitimate product use information and a firsthand product review from an actual product user rather than a paid sales person who might not even actually own and use the product in question and have little actual information about the product aside from marketing scripts. The system incentivizes existing customers providing a new revenue stream from products they already own and likely care about. Additionally, the system eliminates the need for retail stores and sales people along with their overhead, salaries, and expenses allowing cost savings to be passed onto the consumer and/or kept by the product company, reducing significant inefficiency of the overall sales and marketing process, and it is all packaged in one easy to use purpose built shopping device. In summary, the technology described herein combines and expands all the advantages of retail and direct sales models while reducing their disadvantages.

Implementations of this technology relate to a specialized handheld shopping device linked to marketing and sales software systems via computer networks and the internet. The system also relates to products that are sold via mail order and online catalogs and shipped directly to consumers through a direct sales channel. Implementations of the disclosed technology are related to word of mouth product marketing and referral systems that incentivize consumers to actively give product demonstrations to others. As mentioned, the operations disclosed herein can be implemented in one or more mobile devices.

Four or more scenarios can lead to an existing customer giving a product demonstration to a prospective customer.

Scenario 1: an existing customer happens to be in the same location as a prospective customer and the product to be demonstrated. Examples of this scenario could include both people being at a workplace and the existing customer having the product in question on their person, a fishing pole being a specific example. This would then lead to the existing customer giving a product demonstration to the prospective customer. The contact details of the prospective customer can be recorded into the shopping device owned by the existing customer.

Scenario 2: a prospective customer does a specific product search their own shopping device for existing customers who are willing to meet and give a product demonstration. The shopping device facilitates communication, mapping, and scheduling of a meeting place, time, and location. The existing customer and the prospective customer meet for a product demonstration.

Scenario 3: a prospective customer does a general search for any product near their current location that are available for product demonstrations by any existing customer for any product in the system by utilizing search features on the shopping device. The shopping device facilitates communication, mapping, and scheduling of a meeting place, time, and location for the prospective customer for any number of meetings with existing customers, perhaps all in one neighborhood in a dense urban area.

Scenario 4: a prospective customer is identified by general marketing activities of a product company. The system and method allows the product company to contact both the prospective customer and existing customers and send them shopping devices to find a match and arrange a meeting for a product demonstration.

The shopping devices can be closely integrated with numerous services including but not limited to social networking (user profiles for both prospective and existing customers), reputation management and reviews, mapping and communication services, product company marketing and promotions, product company CRM, inventory warehousing, just in time manufacturing and made to order manufacturing, eCommerce and fulfillment, product returns and customer service, and the referral incentive aspect of the system described below.

A prospective customer can use his/her handheld shopping device to search for products available nearby to see in in-person demonstrations. The prospective customer can select a product on his or her shopping device, to then see which existing customers are available nearby to show the product. This is done by the shopping device sending a message to a local wired or wireless network that is in turn sent to a server and database that has a list of existing customer that own the product of current interest. The server then sends a list of existing customers to the prospective customer's shopping device. The existing customer then selects an existing customer to communicate with—these communications can be sent over the same network to the same servers. The existing customer receives a message on their own shopping device notifying them that a prospective customer would like to meet to see a given product.

The existing customer can accept or decline the prospective customer's request. If declined, the prospective customer will receive a message informing him or her of such and the prospective customer can then select a different existing customer to meet. If the existing customer accepts the prospective customers request, various messages are sent back and forth between the prospective customers shopping device and the existing customers shopping device—all via the local network and via the central server and database. These communications can allow the individuals to select a time and place to meet in person for a product demonstration. The specific time and place for the meeting will be recorded in a database. In some embodiments, a specific time and place is determined for the users using one or more calendaring applications. The system can then send reminder notifications to both the prospective customer and the existing customer when the meeting appointment is approaching. Once the meeting has a occurred, the existing customer can record on their shopping device that the meeting is complete—this is then recorded in a database. The system can then send messages to the prospective customers shopping device, offering them a product coupon and discount for the product he or she just saw and prompting them to complete a direct sale with the product company via their shopping device. Once the product has been ordered and delivered, the prospective customer is sent messages to their shopping device requesting that they join the demonstration program to become available to others in the future for in person product demo. In addition, the existing customer who did the product demonstration is awarded a commission or other referral amount at the completion of the sale. Various information about commissions is displayed on the shopping device.

Once the prospective customer, the existing customer, and the product(s) are in the same location, the existing customer gives the prospective customer a hands on demonstration of the product(s). By this point, identifying data has been recorded by the shopping device and stored in central databases linking the existing customer and the prospective customer for use in the referral aspect of the system described below. Then with the shopping device the prospective customer continues the sales process in a similar fashion to existing eCommerce applications—entering the product into a shopping cart, and submitting shipping and payment information. This can all happen immediately after the product demonstration or could occur at a later time at a different location. The product company can use integrated CRM and sales pipeline software to encourage the prospective customer to complete a sale if this does not happen immediately after the product demonstration. Push type prompting message can be sent to the shopping device owned by the prospective customer.

Once the order has been placed with the system, it will be submitted for fulfillment by the product company associated with any product(s) included in the order. A single order could include products from more than one product company included in the system. Shipment will be to the location specified by the prospective customer in the order. The shopping device and linked servers and databases will also record a referral for the existing customer—notifying the existing customer of a reward or compensation as part of the referral system. This could happen via a dashboard, push communications to the shopping device, emails, or other communications. Referral compensation can be configurable and contextual based on settings selected by the product company and/or the existing customer along with purchase specific circumstances. The referral compensation can include but is not limited to cash, discounts, points, gift cards, purchase credit in the overall system, or other such rewards.

Once the purchase is completed, the new customer is invited to participate in the referral program allowing the overall system to expand and they will be sent their own shopping device for future interactions. The product company could also invite an existing customer to join the referral program based on order history. Further, existing customers in the referral program could be prompted to browse newly added products that they might already own, and thus becoming available to demonstrate these products to prospective customers.

Thus implementations of the described technology integrate and link multiple shopping devices with servers running backend software, integrated services, prospective customers, existing customers who have purchased and possess a product(s), the company that sells the product(s) and their direct sales channel, and a referral system to incentivize and compensate the existing customer to demonstrate the product to prospective customers. Existing customers are encouraged by the product company to own and use the shopping device. Existing customers can demonstrate the company's product in person to prospective customers and then use the shopping device to begin a direct sales channel purchase.

The prospective customer after viewing the product in person can enter their contact information (e.g., email or phone number) into the shopping device. Alternatively, the prospective customer can search with their own shopping device for product(s) near their location that are available for first hand demonstration and make appointments with existing customers for demonstrations. The associated servers and databases can then link the prospective customer and the existing customer for later use in the referral system. The prospective consumer's contact information is also now recorded for future marketing efforts by the product company.

The shopping devices can be integrated with calendaring, mapping, and communication systems to facilitate meeting times and locations and communications. The prospective consumer can use the shopping device to further continue the purchasing process by entering payment and shipping information after the product demonstration. This information is submitted for payment processing and direct product fulfillment through one or more integrated e commerce platforms. Once the prospective customer purchases a product, they are invited to enter the referral program thereby enlarging the network and will be sent their own shopping device for future interactions. Also, a product company can invite existing consumers into the referral system based on previous order history. Or a user can be prompted to enter the referral system for a product they already own that is available for purchase within the network. After each purchase, the referring existing customer is notified via email, push communication to the shopping device, website, a dashboard, or other aspect of the system of their referral compensation.

### Operation

In operation, one uses the shopping device in the context of demonstrating a product. For example, a prospective customer and/or existing customer can perform one or more of the following operations on the device: a prospective customer entering their contact information such as email address or phone number into the shopping device, a prospective customer searching or browsing for a specific product, a prospective customer searching for products near the prospective customer available for product demonstrations, an existing customer inviting friends, family, and colleagues to demonstrations by using software integrated with email, social networking or other communication mechanisms, a prospective customer purchasing a product by entering data into the shopping device at the location the product was demonstrated, a prospective customer who has entered contact information into the shopping device who has not yet purchased a product being prompted to complete the purchase process by product company emails, push communications, or other communications that are part of an integrated CRM system or sales pipeline software. Thereafter, the system can incorporate the purchase into standard eCommerce systems and workflows. After purchase, the existing customer can be notified of referral compensation via email or other push communication, or through a webpage or application dashboard, and finally the existing customer can redeem their referral compensation through additional workflows.

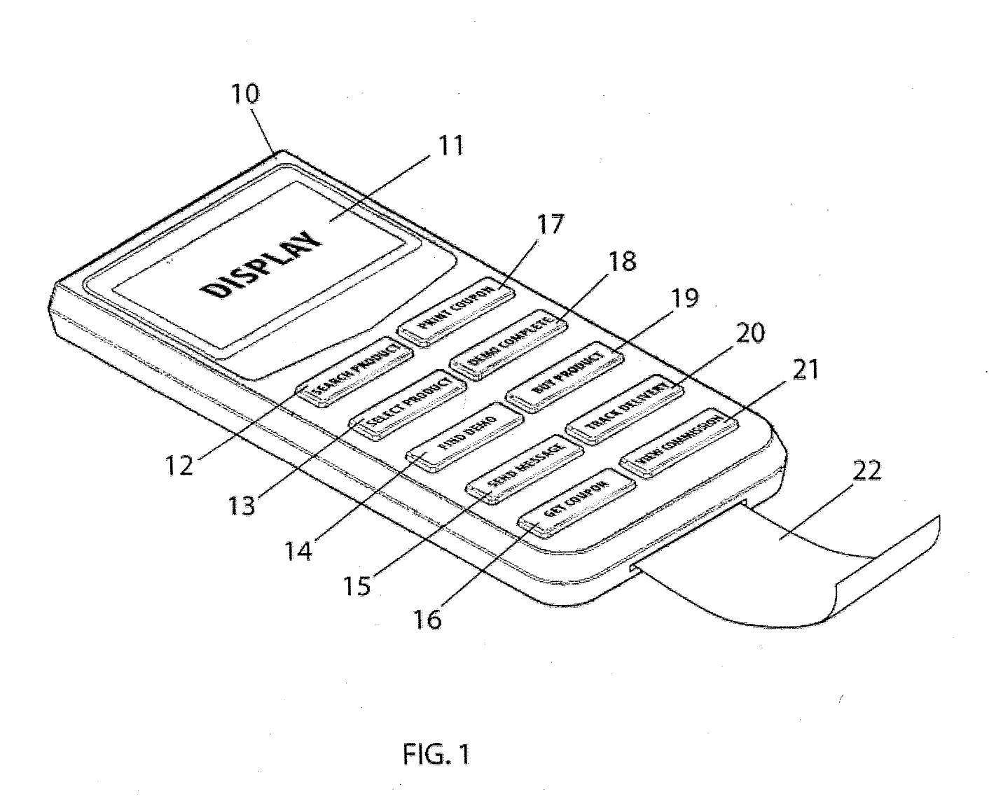

Several implementations are discussed below in more detail in reference to the figures. Turning now to the figures, FIG. 1 shows one embodiment of the shopping device 10. It can include a display 11 that uses LCD technology or other digital display or analog technology. Display 11 can also include a touch or multi-touch surface for further virtual controls such as alpha numeric keyboard or other controls. Numerous buttons or controls are used to operate the device: 12 is a “search products” control when pressed will display nearby product information on display 11, 13 is a “select product” control, 14 is a “find demo” control which will show possible product demonstration opportunities on display 11, 15 is a “send message” control, 16 is a “get coupon” control, 17 is a “print coupon” control that can be linked to onboard printer 22 or can a coupon can be shown on display 11. 18 is a “demo complete” control, 19 is a “buy product” control, 20 is a “track delivery” control, 21 is a “view commission” control. The device can also include one or more audio speakers or microphones to facilitate audio communications and data (not shown). Although the device shown in FIG. 1 includes buttons, in some embodiments, the buttons can be included in one or more applications installed on a device.

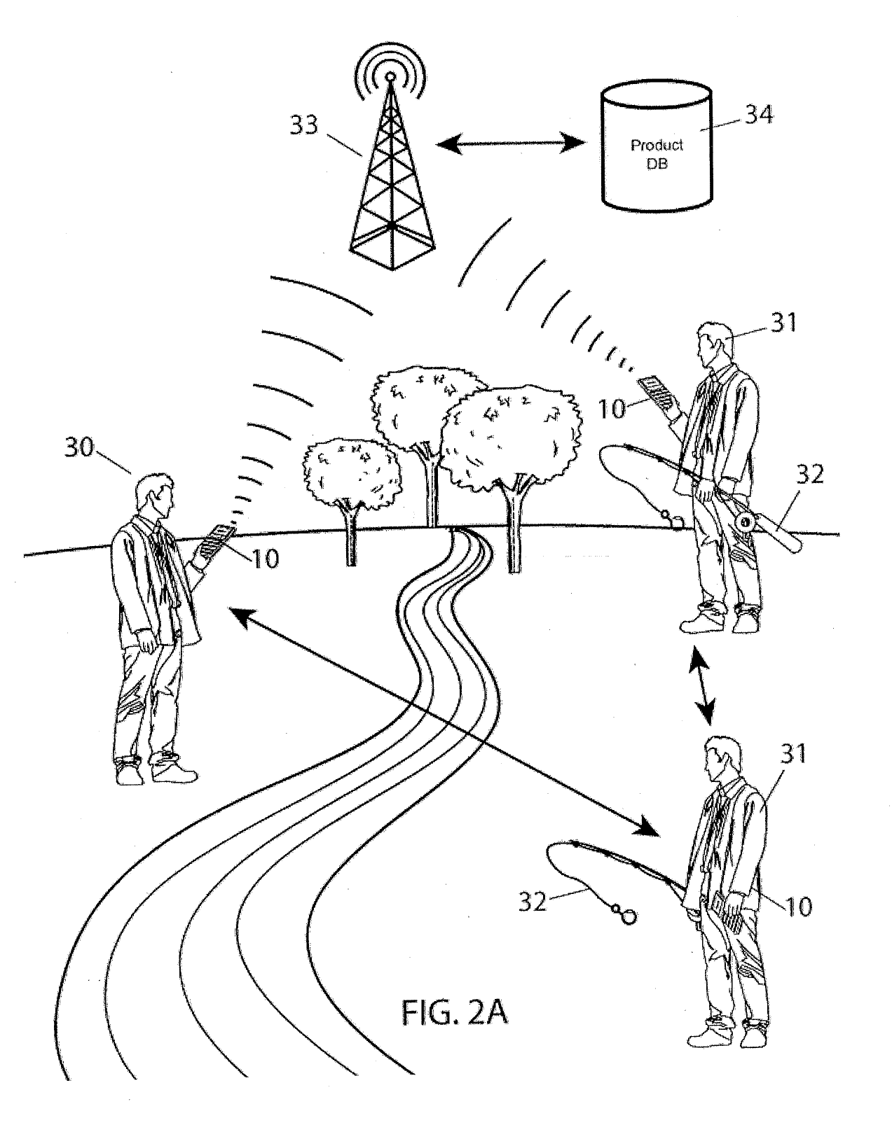

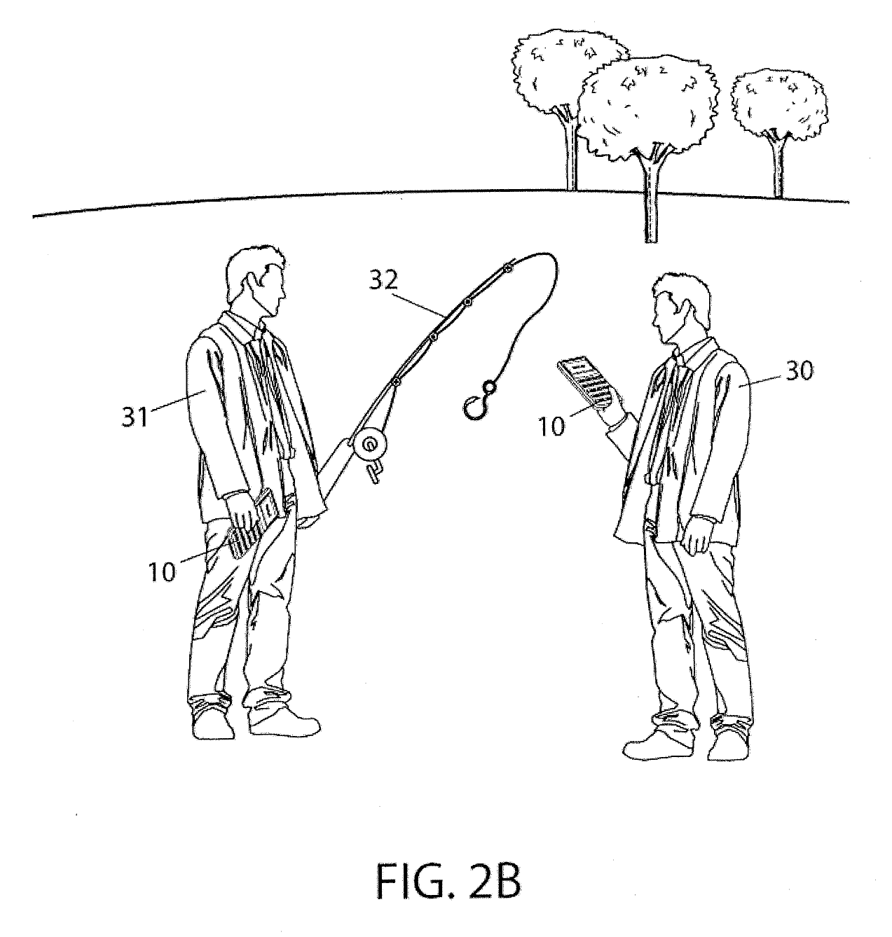

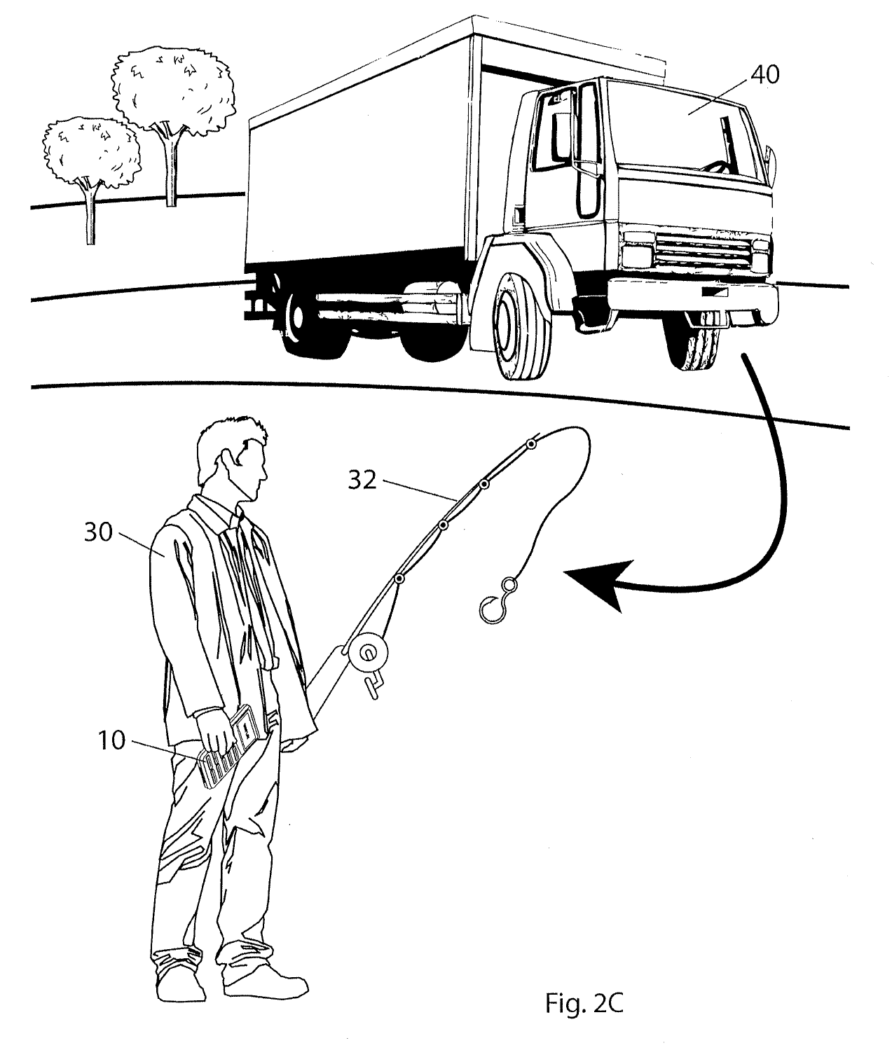

FIG. 2A shows a prospective customer using their shopping device 10 to search for products and product demonstrations available nearby (e.g., within a threshold distance of the shopping device 10). The shopping device sends messages via a local wireless network 33. The search request then connects to a backend server and product database 34. An existing customer 31 is located nearby who is in possession of their own shopping device 10 as well as a product to be demonstrated, in this case a fishing pole 32. The existing customer 31 receives messages from the server on their shopping device 10 to schedule a product 32 demonstration at a nearby location with prospective customer 30.

FIG. 2B shows existing customer 31 meeting in person with prospective customer 30. The meeting was arranged using shopping devices 10. The product 32 is demonstrated. The prospective customer can then use their shopping device 10 to order the product 32 to be shipped to their own home or other location at a later time.

FIG. 2C shows the prospective customer 30 receiving a delivery of their own product 32, in this case a fishing pole, from a delivery truck 40. The order and delivery can be tracked on shopping device 10. At their option, the prospective customer 30 can select to be available in the future to give product demonstrations to others.

In some implementations, the device 10 also includes a communication device capable of communicating wirelessly or wire-based with a network node. The communication device can communicate with another device or a server through a network using, for example, TCP/IP protocols. Device 10 can utilize the communication device to distribute operations across multiple network devices.

Some implementations Device 10 can be operational with numerous other general purpose or special purpose computing system environments or configurations. Examples of well-known computing systems, environments, and/or configurations that may be suitable for use with the technology include, but are not limited to, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

Network 33 can connect to a local area network (LAN) or a wide area network (WAN), but can also be other wired or wireless networks. Network 33 may be the Internet or some other public or private network. Shopping Devices 10 can be connected to network 33 through a network interface, such as by wired or wireless communication. While the connections between server 34 are shown as separate connections, these connections can be any kind of local, wide area, wired, or wireless network, including network 33 or a separate public or private network.

Those skilled in the art will appreciate that the components illustrated in FIGS. 1-2C described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

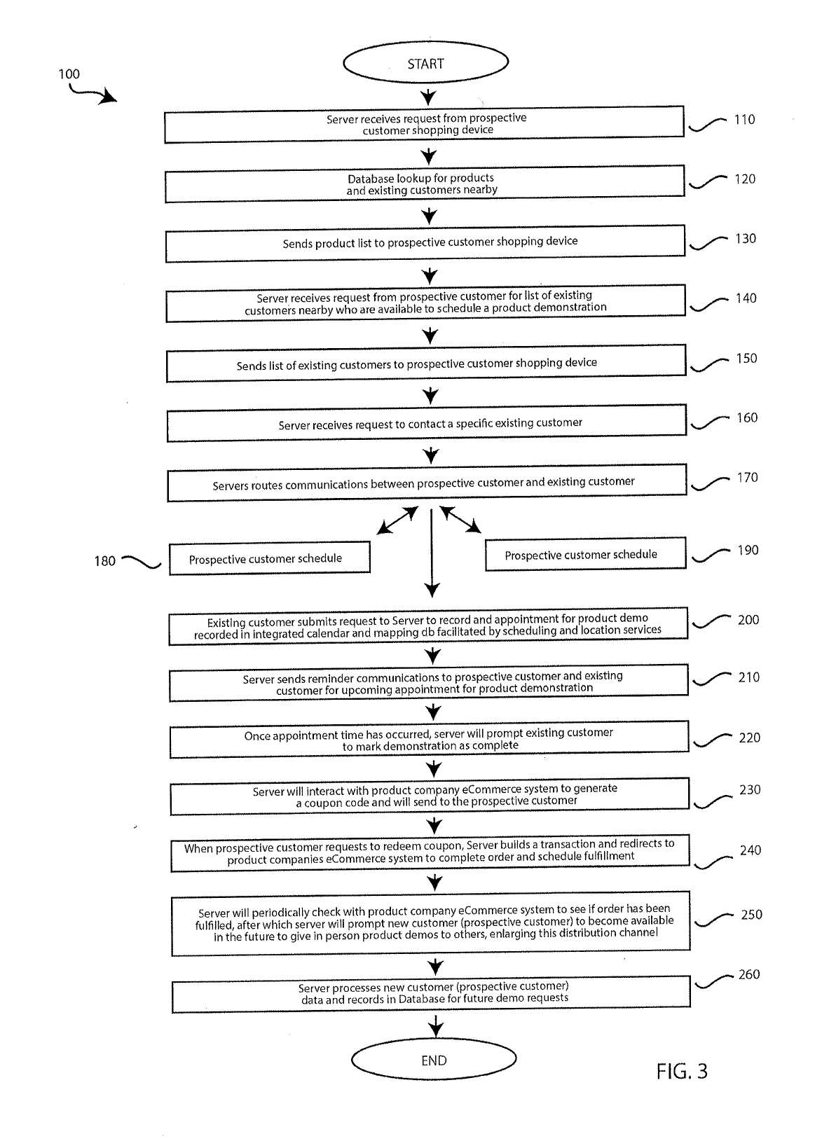

FIG. 3 is a flowchart showing a sequence of steps performed by the system. The server receives a request from prospective customer shopping device in operation 110. Then, the system performs a database lookup operation that searching for products and existing customers nearby in operation 120. The server then sends a product list to be displayed on the prospective customer shopping device in operation 130. The server receives a further request from the prospective customer for list of existing customers nearby (i.e., within a threshold distance defined by the system or by the preferences of the user) who are available to schedule a product demonstration in operation 140. The server then sends this list of existing customers to be displayed on the prospective customer shopping device in operation 150.

The server then receives a request from the prospective customer to contact a specific existing customer to schedule a product demonstration in operation 160. The server routes communications between prospective customer and existing customer in operation 170. The server (and/or existing customer) receives scheduling information from the prospective customer in operation 180, while concurrently the server (and/or prospective customer) receives scheduling information existing customer sends scheduling information in operation 190. The server proposes a meeting time amenable to both schedules which is displayed on the existing customers shopping device display. The existing customer submits request to Server to record this appointment for the product demonstration, which is recorded in the integrated calendar and mapping database in operation 200.

The server sends reminder communications to prospective customer and existing customer for upcoming appointment for product demonstration in operation 210. Once the appointment time has occurred, the server will prompt the existing customer to mark demonstration as complete in operation 220. The server will interact with product company eCommerce system to generate a coupon code and will send the coupon code to the prospective customer in operation 230. When the prospective customer requests a coupon redemption, the server builds a transaction and redirects to product companies eCommerce system to complete order and schedule fulfillment in operation 240. The server will periodically check with product company eCommerce system to determine whether the order has been fulfilled, after which the server will prompt the new customer (prospective customer) to become available in the future to provide in-person product demonstrations to others, enlarging the distribution channel in operation 250. The server processes new customer (prospective customer) data and records such data in the database for future demonstration requests in operation 260.

In conclusion, implementations described herein include one or more shopping devices connected to servers running backend software, integrated services, prospective customers, existing customers who have purchased and possess a product(s), the company that sells the product(s) and their direct sales channel, and a referral system to incentivize and compensate the existing customer to demonstrate the product to prospective customers. Existing customers are encouraged by the product company to use the shopping device. Existing customers can demonstrate the product company product in person to prospective customers and then use the shopping device to begin a direct sales channel purchase. The prospective customer after viewing the product in person can enter their email or phone number into the shopping device. Alternatively the prospective customer can the shopping device for product(s) near their location that are available for first hand demonstration and make appointments with existing customers for demonstrations.

Linked databases can associate the prospective customer and the existing customer for later use in the referral system. The prospective consumer's contact information can be recorded for use in future marketing efforts by the product company. The shopping device can be integrated with calendaring, mapping, and communication systems to facilitate meeting times and locations and communications. The prospective consumer can use the shopping device to further continue the purchasing process by entering payment and shipping information after the product demonstration. This information is submitted for payment processing and direct product fulfillment through one or more integrated e-commerce platforms. Once the prospective customer purchases a product, the prospective customer is invited to take possession of their own shopping device and enter the referral program thereby enlarging the network. Also, a product company can invite existing consumers into the referral system based on previous order history. Or a user can be prompted to enter the referral system for a product he or she already owns that is available for purchase within the network. After each purchase, the referring existing customer can be notified via email, mobile app, website, a dashboard, or other aspect of the system of their referral compensation.

I/we claim:

1. A computerized method comprising:
receiving, from a computing device of a prospective buyer of a product, a request for a product demonstration;
determining a location of the prospective buyer;
searching, by the server, a database of registered existing customers to identify existing customers of the product to provide the product demonstration in exchange for a referable fee;
detecting, in real-time, locations of the existing customers based at least in part on locations of computing devices associated with the existing customers;
generating a list of the existing customers detected to be within a threshold distance of the location of the prospective buyer;
causing the list of the existing customers to be displayed on the computing device of the prospective buyer;
after receiving a selection of one of the existing customers, determining a meeting time and place for the product demonstration; and
when a purchase of the product is received from the computing device of the prospective buyer, transferring, via a communications network, the referral fee to an account associated with the existing customer.

2. The computerized method of claim 1, wherein when the purchase is received, the computerized method further comprises sending, via the communications network to the computing device of the existing customer, an invitation to enter a referral program.

3. The computerized method of claim 1, wherein determining the location of the prospective buyer comprises detecting a location of the computing device of the prospective buyer using at least one of GPS or cell phone triangulation.

4. The computerized method of claim 1, wherein determining the meeting time comprises:
reviewing, by the server, a calendar of the existing customer;
reviewing, by the server, a calendar of the prospective customer; and
matching a time on each calendar indicated as available.

5. The computerized method of claim 1, wherein determining the meeting place comprises:
determining a proposed location an equal distance from the location of the prospective buyer and the existing customer; and
causing the proposed location to be displayed on the computing device of the prospective buyer and the computing device of the existing customer.

6. The computerized method of claim 1, wherein the list of existing customers includes information relating to length of time the existing customer has owned the product.

7. The computerized method of claim 1, further comprising after receiving the purchase, sending a notification to computing device associated with a seller of the product.

8. A product verification platform comprising:
one or more processors; and
a computer readable storage medium having instructions stored thereon, which when executed by the one or more processors cause the product demonstration platform to:
receive, from a device associated with the prospective buyer, a request for a product demonstration of a product;
determine, from a network of devices associated with product demonstrators, a device associated with a product demonstrator that is within a threshold distance of the device associated with the prospective buyer;
arrange a meeting between the product demonstrator and the prospective buyer;
during or after the meeting, cause a product purchase page to be displayed on the device associated with the prospective buyer; and
after receiving a selection to purchase the product, sending a notification to a provider of the product.

9. A non-transitory computer-readable storage medium including a set of instructions that, when executed by one or more processors, cause a machine to::
receive, from a computing device of a prospective buyer of a product, a request for a demonstration of a product or a service;
search, by the server, a database of registered existing customers to identify an existing customer of the product or the service to provide the demonstration in exchange for a referral fee;
arrange, by the server, a meeting for the demonstration; and
when a purchase of the product or service is received from the computing device of the prospective buyer, send a notification to a provider of the product or service, wherein the existing customer receives the referral fee.
